(19) United States
(12) Patent Application Publication
(10) Pub. No.: US 2005/0097542 A1
(43) Pub. Date: May 5, 2005

(54) Firmware update method and system

(76) Inventor: Steve Lee, Taipei (TW)

Correspondence Address: RABIN & Berdo, PC, 1101 14TH STREET, NW, SUITE 500, WASHINGTON, DC, 20005, US

(21) Appl. No.: 10/868,845

(22) Filed: Jun. 17, 2004

(30) Foreign Application Priority Data
Oct. 31, 2003 (TW) 92130424

(51) Int. Cl. G06F 9/44

(52) U.S. Cl. 717/168

(57) ABSTRACT

A firmware update method. First, a tag is written to a firmware storage device. Next, first firmware in the firmware storage device is replaced by second firmware. If the replacing step is successful, the tag is deleted. Before the execution of the second firmware, a verification operation is executed. If the tag is not present, the second firmware is executed. If the tag is present, an abnormity processing procedure is executed. The abnormity processing procedure terminates of execution of the second firmware, reads third firmware via an interface, and replaces the second firmware with the third firmware.

### BACKGROUND OF THE INVENTION

1. Field of the Invention

The present invention relates to firmware technology and in particular to a firmware update method and system.

2. Description of the Related Art

In present computer-related applications, most hardware, such as ODDs (optical disc drives) or modems, is enabled and executed by firmware, such as an ODD (optical disc drive) or a modem. The firmware storage devices have developed from non-erasable to updatable devices, such as EEPROM (electrically erasable programmable read only memory) or flash ROM. Thus, firmware update methods have changed accordingly. In the previous conventional method for updating firmware, the device with the firmware to be updated is returned to the manufacturer. In the present firmware update method, however, a firmware application is downloaded from the website of the manufacturer over Internet.

Nevertheless, some extraordinary situations may occur when updating firmware by the described present method. For example, power device failure or user error may result in errors during the firmware update. Additionally, defects in certain operating systems may be revealed during the firmware update, causing failure.

Firmware update failure probably impedes the device operated by the firmware, such as an optical disc drive, performing normally. As a result, user cannot load programs from the Internet for updating the firmware. Thus, the device must be returned to the manufacturer for repair and updating, causing inconvenience and incurring additional cost.

Thus, a method enabling firmware to be executed even when a firmware update fails, is needed.

### SUMMARY

Accordingly, an object of the invention is to maintain executability of firmware when a firmware update fails. The inventive method can terminate the execution of the failed firmware, leaving the original firmware in a safe execution mode. Thus, the firmware can read other repair programs or update programs via an interface, such as an integrated device electronics interface (IDE interface), to recover the device possessing the firmware, ensuring normal operation of the device or system.

To achieve the foregoing and other objects, the invention discloses a firmware update method for updating first firmware in a firmware storage device. The method first writes a tag to the firmware storage device. Next, the method replaces the first firmware with second firmware. Finally, the method deletes the tag if the replacement is successful.

### BRIEF DESCRIPTION OF THE DRAWINGS

The present invention can be more fully understood by reading the following detailed description and examples with references made to the accompanying drawings, wherein:

FIG. 1 is a flowchart of the firmware update method according to one embodiment of the present invention.

FIG. 2 is a flowchart of the abnormity processing procedure of the firmware update method according to one embodiment of the present invention.

FIG. 3 is a flowchart of the firmware update method according to another embodiment of the present invention.

FIG. 4 is a diagram of the machine-readable storage medium for storing a computer program providing the firmware update method. (FIG. 4 includes FIG. 4a and FIG. 4b)

FIG. 5 is a diagram of a firmware update apparatus according to one embodiment of the present invention.

FIG. 6 is a diagram of a firmware update apparatus according to another embodiment of the present invention.

FIG. 7 is a diagram of the firmware update system according to the present invention.

### DETAILED DESCRIPTION OF THE INVENTION

As summarized above, the present invention discloses a firmware update method for updating first firmware in a firmware storage device. The firmware storage device can be a flash ROM or an EEPROM.

First, a tag is written to the firmware storage device. Next, the first firmware is replaced by second firmware. The tag can be written by the first firmware or the second firmware before the replacement. Finally, the tag is deleted if the replacement is successful or reserved if the replacement is not successful. Thereafter, the second firmware is executed. Before execution of the second firmware, it is verified if the tag is exists. If the tag is present, representing firmware update unsuccessful, an abnormity processing procedure is then executed. If the tag is not present, representing firmware update successful, the second firmware is executed.

The abnormity processing procedure comprises certain steps. First, third firmware is read via an interface, e.g. an integrated device electronics interface (IDE interface). The second firmware is then replaced by the third firmware.

As mentioned above, the inventive method can resolve the problem of firmware update failure. The inventive method adds a tag to a firmware storage device and verifies if the tag exists before the updated firmware is executed for determining if the execution of an abnormity processing procedure is necessary. The abnormity processing procedure ensures that the firmware storage device is executed in safe mode instead of the execution of the error firmware, thus reducing inconvenience for users and manufacturer alike.

Furthermore, to prevent damage to devices or systems from firmware update failure, manufacturers typically select firmware storage devices adopting small section write policy, such as page write or small sector type. Firmware storage devices adopting small section write policy, however, are expensive. The present invention can resolve the problem of high cost, by ameliorating the firmware update failure, thus, the selection of a firmware storage device is not limited and can be a byte write mode firmware storage device, for example, thus reducing costs.

Additionally, the present method discloses a machine-readable storage medium for storing a computer program providing a firmware update method for update first firmware in a firmware storage device. The method comprises the above mentioned steps.

The present invention provides another firmware update method for updating first firmware in a firmware storage device, wherein the first firmware has a first tag. The firmware storage device can be a flash ROM or an EEPROM.

First, the first tag is deleted. Next, the first firmware is replaced by second firmware. Finally, a second tag is written to the firmware storage device if the replacement is successful. Thereafter, the second it is verified if the tag is present. If the second tag is present, the second firmware is executed. Otherwise, an abnormity processing procedure is executed.

The abnormity processing procedure first terminates the execution of the second firmware. Third firmware is read by the abnormity processing procedure via an interface, such as IDE interface. The abnormity processing procedure then replaces the second firmware with the third firmware.

Moreover, the invention discloses a storage medium for storing a computer program for providing a firmware update method for updating first firmware in a firmware storage device, wherein the first firmware has a first tag. The method comprises the mentioned steps.

The invention also provides a firmware update system. In one embodiment, the provided system includes a firmware storage device and a main chip. The firmware storage device has first firmware. The main chip writes a tag to the firmware storage device when the first firmware is replaced by second firmware and deletes the tag if the replacement is successful. If the replacement is successful, the main chip executes the second firmware. Before execution of the second firmware, the main chip verifies if the tag is present, if so, an abnormity processing procedure is executed. In the abnormity processing procedure, the main chip reads third firmware via an interface, such as an IDE interface, and replaces the second firmware with the third firmware.

The present invention additionally provides a firmware update system. In another embodiment, the system includes a firmware storage device and a main chip. The firmware storage device has first firmware and a first tag. The main chip deletes the first tag when the first firmware is replaced with second firmware and adds a second tag if the replacement is successful. After successful replacement, the main chip further executes the second firmware. Before execution of the second firmware, the main chip determines if the second tag is present and if not present executes an abnormity process procedure.

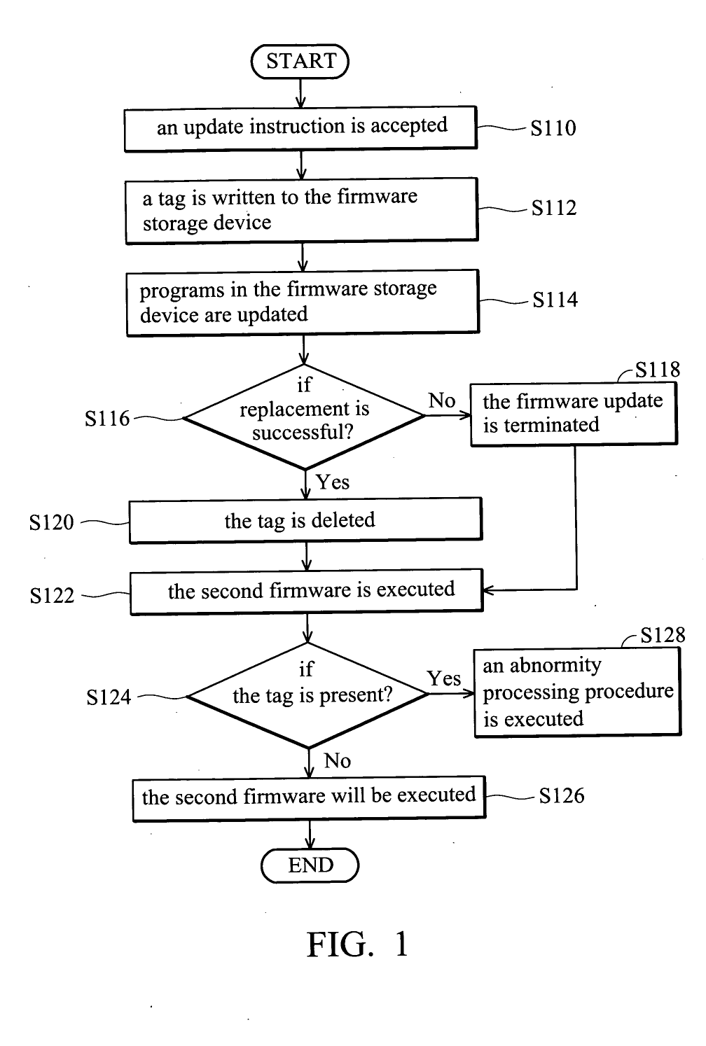

FIG. 1 is a flowchart of the firmware update method according to one embodiment of the present invention. In one embodiment, a firmware update method for updating first firmware in a firmware storage device is provided. The firmware storage devices may be a flash ROM or an EEPROM.

First, an update instruction is accepted (step S110) and a tag is written to the firmware storage device (step S112). The tag can be written by firmware or update programs.

Next, programs in the firmware storage device are updated (step S114), that is, the first firmware is replaced by second firmware. In step s116, it is determined if replacement is successful. If so, the tag is deleted (step S120). If replacing step s116 fails, the firmware update is still terminated but the tag will not be deleted (step S118). For example, the programs may enter a recursive loop that terminates after certain number of executions without deleting the tag.

Subsequently, the second firmware is executed (step S122). Before execution of the second firmware, it is determined if the tag is present (step S124). If not, i.e. the firmware was updated successfully, the second firmware will be executed (step S126). If the tag is present, an abnormity processing procedure is executed (step s128).

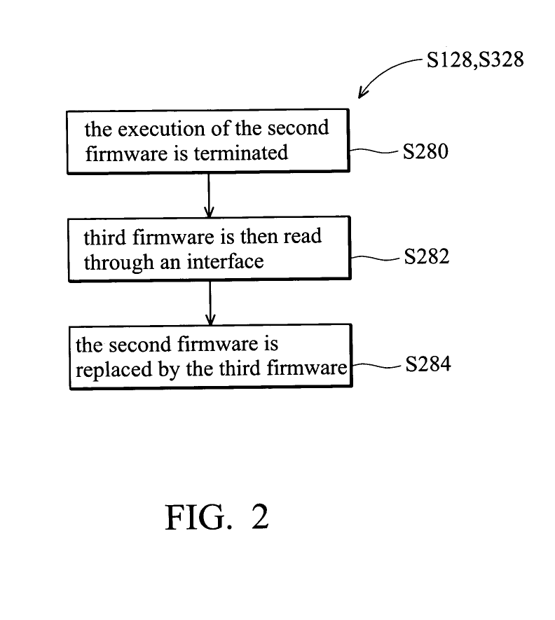

FIG. 2 is a flowchart of the abnormity processing procedure of the firmware update method according to one embodiment of the present invention. In the step S128 in FIG. 1, the abnormity processing procedure comprises certain steps. First, the execution of the second firmware is terminated (step S280). Third firmware, e.g. an update program, is then read through an interface (step S282). Finally, the second firmware is replaced by the third firmware (step S284), e.g. the update program is written to the firmware.

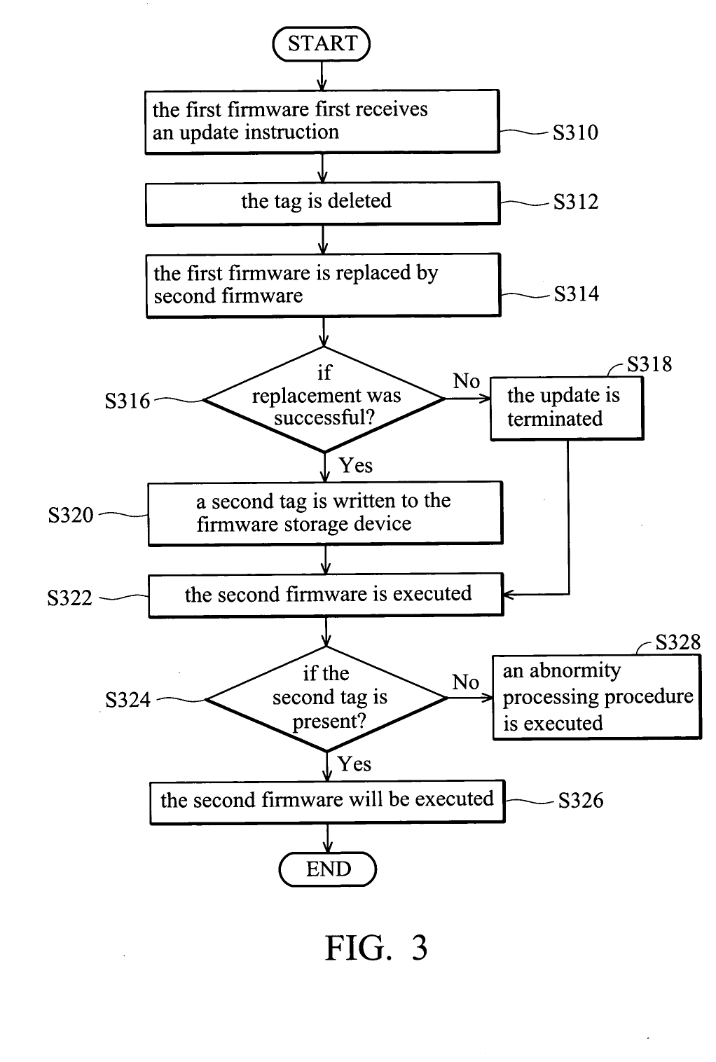

FIG. 3 is a flowchart of the firmware update method according to another embodiment of the present invention. In another embodiment, the invention provides a firmware update method for updating first firmware in a firmware storage device, wherein the first firmware has a first tag. Here, again, the firmware storage devices can be a flash ROM or an EEPROM.

In the embodiment, the first firmware first receives an update instruction (step S310) and deletes the tag (step S312). Next, the first firmware is replaced by second firmware (step S314). It is then determined if replacement was successful (step S316). If so, a second tag is written to the firmware storage device (step S320). If not, the update is still terminated without writing the second tag (step S318).

Thereafter, the second firmware is executed (step S322). Before execution of the second firmware, it is determined if the second tag is present (step S324). If so, i.e. the firmware update was successful, the second firmware will be executed (step S326). If not, i.e. the firmware update was failed, an abnormity processing procedure is executed (step S328). The first and the second tags can be written in the same location or in a different location of the firmware storage device.

The step S328 of FIG. 3 is accomplished by certain steps as shown in FIG. 2. First, execution of the second firmware is terminated (step S280). Third firmware is then read through an interface (step S282). Finally, the second firmware is replaced by the third firmware.

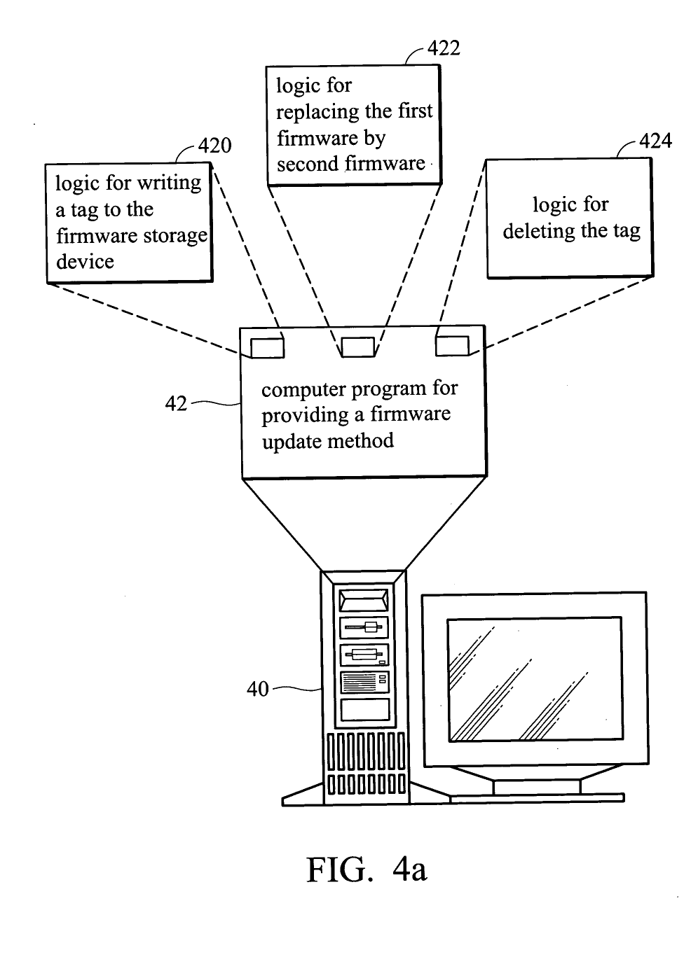

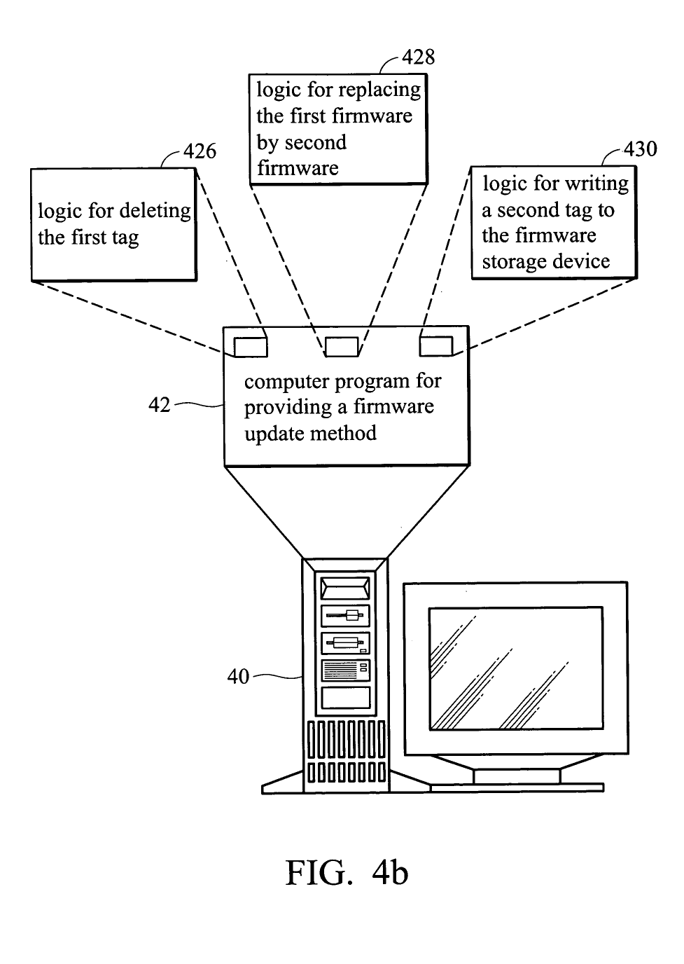

FIG. 4 is a diagram of the machine-readable storage medium storing a computer program providing the firmware update method (FIG. 4 includes FIG. 4a and FIG. 4b). In one embodiment, as shown in FIG. 4a, the present invention discloses a machine-readable storage medium 40 for storing a computer program 42 providing a firmware update method for updating first firmware in a firmware storage device. The computer program 42 mainly includes logic for writing a tag to the firmware storage device 420, logic for replacing the first firmware by second firmware 422, and logic for deleting the tag 424.

In another embodiment, as shown in FIG. 4b, the present invention discloses a storage medium 40 for storing a computer program 42 for providing a firmware update method for updating first firmware in a firmware storage device, wherein the first firmware has a first tag. The computer program 42 mainly includes logic for deleting the first tag 426, logic for replacing the first firmware by second firmware 428, and logic for writing a second tag to the firmware storage device 430.

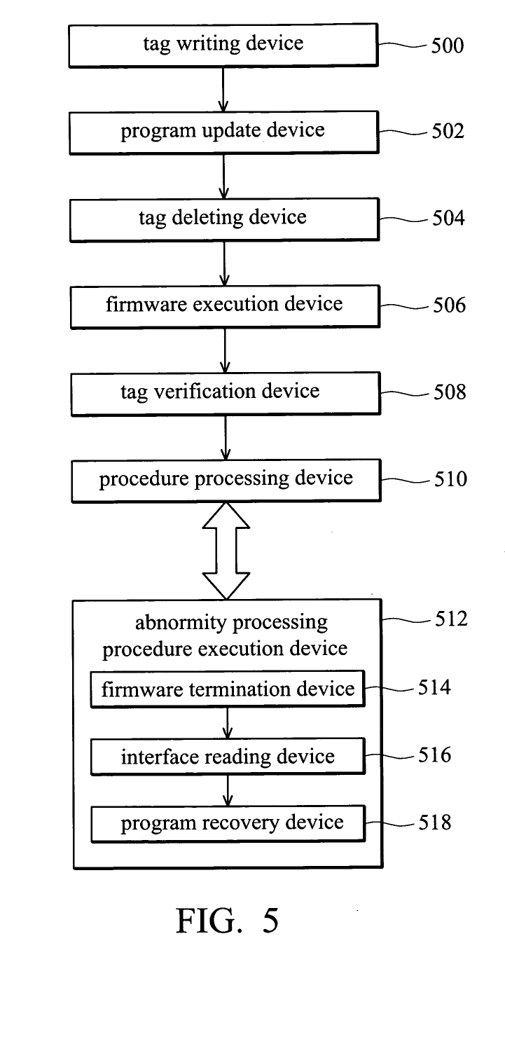

FIG. 5 is a diagram of a firmware update apparatus according to one embodiment of the present invention. In one embodiment, the disclosed apparatus includes a tag writing device 500, a program update device 502, a tag deleting device 504, a firmware execution device 506, a tag verification device 508, and a procedure processing device 510.

The tag writing device 500 writes a tag to the firmware storage device. The program update device 502 updates update programs to the firmware storage device. The tag deleting device 504 deletes the tag if the update is successful. The firmware execution device 506 executes the firmware after updating. The tag verification device 508 verifies if the tag is present. The procedure processing device 510 executes the firmware if the tag is not present, and executes an abnormity processing procedure execution device 512 if the tag is present.

The abnormity processing procedure execution device 512 includes a firmware termination device 514, an interface reading device 516, and a program recovery device 518. The firmware termination device 514 terminates the execution of the firmware. The interface reading device 516 reads recovery programs through an interface. The program recovery device 518 writes the recovery programs to the firmware storage device.

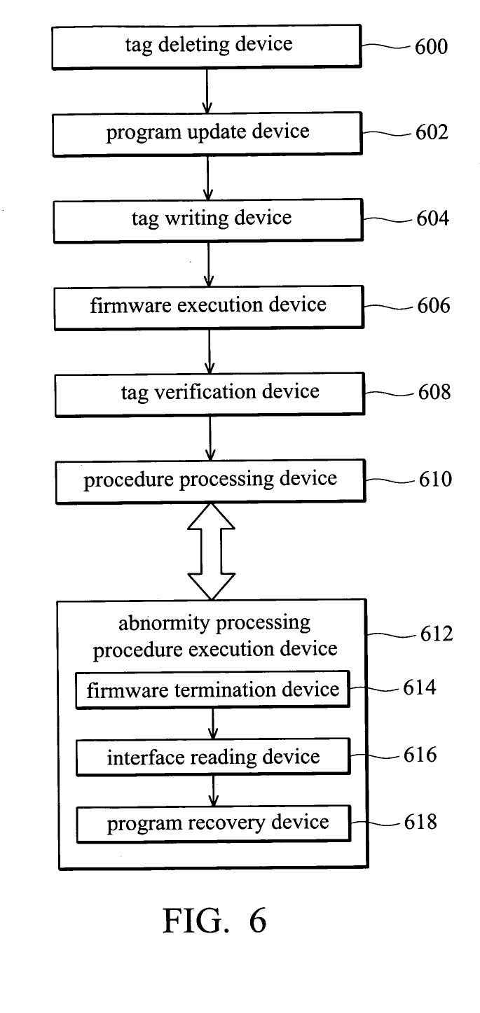

FIG. 6 is a diagram of a firmware update device according to another embodiment of the present invention. In another embodiment, the disclosed apparatus includes a tag deleting device 600, a program update device 602, a tag writing device 604, a firmware execution device 606, a tag verification device 608, and a procedure processing device 610.

The tag deleting device 600 deletes a tag in the firmware storage device. The program update device 602 updates programs to the firmware storage device. The tag writing device 604 writes the tag if the update is successful. The firmware execution device 606 executes the firmware after updating. The tag verification device 608 verifies if the tag is present. The procedure processing device 610 executes the firmware if the tag is present, and executes an abnormity processing procedure execution device 612 if the tag is not present.

The abnormity processing procedure execution device 612 includes a firmware termination device 614, an interface reading device 616, and a program recovery device 618. The firmware termination device 614 terminates the execution of the firmware. The interface reading device 616 reads recovery programs through an interface. The program recovery device 618 writes the recovering programs to the firmware storage device.

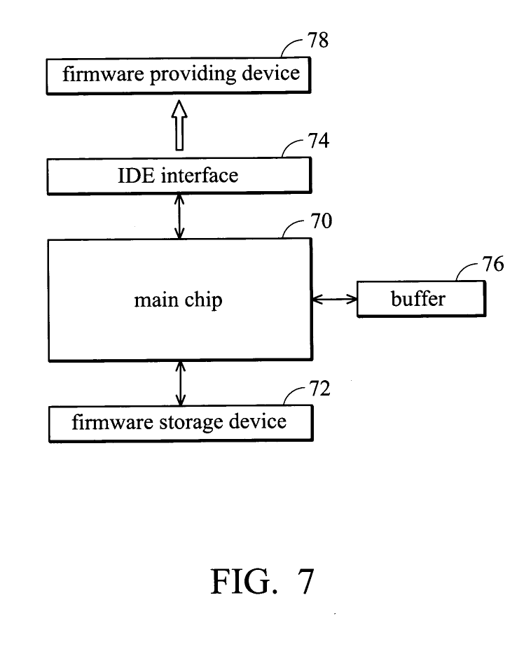

FIG. 7 is a diagram of the firmware update system according to the present invention. In one embodiment, the present invention provides a firmware update system, including a main chip 70, a firmware storage device 72, an IDE interface 74, a buffer 76, and a firmware providing device 78. The firmware storage device 72 can be a flash ROM or an EEPROM. The buffer 76 can be a DRAM (dynamical Read-Only Memory). The firmware providing device 78 can be a computer or an Internet server.

The firmware update may be processed by two methods. In one method, the main chip 70 updates firmware via the IDE interface 74. The system first receives a firmware update instruction. The main chip 70 writes a tag to the firmware storage device 72 to update the original firmware and deletes the tag after the update is successful.

In another method, the firmware updates the firmware. The kernel programs of the firmware are first stored in the buffer 76. After receiving the firmware update instruction, a tag is written to the firmware storage device 72. The firmware is then updated. The tag is deleted if the firmware update is successful.

Regardless of which method is adopted in the inventive system, before the system executes the firmware in the firmware storage device 72, it is determined if the tag is present. If not, representing that the firmware update was successful, the system will execute the firmware. If so, representing that the firmware update was failed, an abnormity processing procedure will be executed. In the abnormity processing procedure, the system first terminates the execution of the firmware in the firmware storage device 72. The system then reads another firmware via an IDE interface 74, and writes the firmware to the firmware storage device 72. Thus, even if the firmware update is unsuccessful, the device with the firmware storage device 72 need not be returned to the manufacturer for firmware recovery.

Thus, a firmware update method and system is provided to resolve the problem of conventional firmware update. Specifically, the inventive method and system can be combined with an optical disc drive or a modem to enhance the utility thereof.

It will be appreciated from the foregoing description that the system and method described herein provide a dynamic and robust solution to the firmware update problem. If, for example, the method of tag writing or the elements of the system are altered, the system and method of the present invention can be adjusted accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over a transmission medium, such as electrical wire, cable, fiberoptics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A firmware update method for updating first firmware in a firmware storage device, comprising the steps of:
writing a tag to the firmware storage device;
replacing the first firmware with a second firmware; and
deleting the tag if the replacing is successful.

2. The method as claimed in claim 1, further comprising reserving the tag if the replacing is unsuccessful.

3. The method as claimed in claim 1, further comprising executing the second firmware, wherein the execution comprises the steps of:
verifying if the tag is present; and
executing the second firmware if the tag is not present.

4. The method as claimed in claim 3, before execution of the second firmware further comprising the steps of:
verifying if the tag is present; and
executing an abnormity processing procedure if the tag is present.

5. The method as claimed in claim 4, wherein the abnormity processing procedure comprises the steps of:
reading third firmware via an interface; and
replacing the second firmware with the third firmware.

6. The method as claimed in claim 1, wherein the tag is written by the first firmware or the second firmware.

7. A machine-readable storage medium for storing a computer program providing a firmware update method for updating first firmware in a firmware storage device, the method comprising the steps of:
writing a tag to the firmware storage device;
replacing the first firmware with second firmware; and
deleting the tag if the replacing is successful.

8. The machine-readable storage medium as claimed in claim 7, further comprising reserving the tag if the replacing is unsuccessful.

9. The machine-readable storage medium as claimed in claim 7, further comprising executing the second firmware, wherein the execution comprises the steps of:
verifying if the tag is present; and
executing the second firmware if the tag is not present.

10. The machine-readable storage medium as claimed in claim 9, before execution of the second firmware further comprising the steps of:
verifying if the tag is present; and
executing an abnormity processing procedure if the tag is present.

11. The machine-readable storage medium as claimed in claim 10, wherein the abnormity processing procedure comprises the steps of:
reading third firmware via an interface; and
replacing the second firmware with the third firmware.

12. The machine-readable storage medium as claimed in claim 7, wherein the tag is written by the first firmware or the second firmware.

13. A firmware update method for updating first firmware in a firmware storage device, wherein the first firmware has a first tag, comprising the steps of:
deleting the first tag;
replacing the first firmware with second firmware; and
writing a second tag to the firmware storage device if the replacing is successful.

14. The method as claimed in claim 13, further comprising the steps of:
verifying if the second tag is present; and
executing the second firmware if the second tag is present and executing an abnormity processing procedure if the tag is not present.

15. The method as claimed in claim 14, wherein the abnormity process procedure further comprises the steps of:
terminating the execution of the second firmware;
reading third firmware via an interface; and
replacing the second firmware with the third firmware.

16. A machine-readable storage medium for storing a computer program providing a firmware update method for updating first firmware in a firmware storage device, wherein the first firmware has a first tag, the method comprising the steps of:
deleting the first tag;
replacing the first firmware with second firmware; and
writing a second tag to the firmware storage device if the replacement is successful.

17. The machine-readable storage medium as claimed in claim 16, further comprising the steps of:
verifying if the second tag is present; and
executing the second firmware if the second tag is not present and executing an abnormity processing procedure if the tag is not present.

18. The machine-readable storage medium as claimed in claim 16, wherein the abnormity processing procedure further comprises the steps of:
terminating the execution of the second firmware;
reading third firmware via an interface; and
replacing the second firmware with the third firmware.

19. A firmware update system, comprising:
a firmware storage device, having first firmware; and
a main chip, writing a tag to the firmware storage device when the first firmware is replaced by second firmware and deleting the tag if the replacement is successful.

20. The system as claimed in claim 19, wherein the main chip further executes the second firmware if the replacement is successful.

21. The system as claimed in claim 20, wherein before the execution of the second firmware, the main chip further verifies if the tag is present and executes an abnormity processing procedure if the tag is present.

22. The system as claimed in claim 21, wherein the main chip further reads third firmware via an interface and replaces the second firmware with the third firmware during the abnormity processing procedure.

23. A firmware update system, comprising:
a firmware storage device, having first firmware and a first tag; and
a main chip, deleting the first tag when the first firmware is replaced by second firmware and adding a second tag if the replacement is successful.

24. The system as claimed in claim 23, wherein the main chip further executes the second firmware after the replacement is successful.

25. The system as claimed in claim 24, wherein before the execution of the second firmware, the main chip further verifies if the second tag is present and executes an abnormity process procedure if the second tag is not present.

26. The system as claimed in claim 25, wherein the main chip further reads third firmware via an interface and replaces the second firmware with the third firmware during the abnormity processing procedure.
